(19) United States
(12) Patent Application Publication
(10) Pub. No.: US 2004/0063464 A1
(43) Pub. Date: Apr. 1, 2004

(54) High-speed data and power source interface cable for mobile devices

(76) Inventors: Tahir Akram, Guelph (CA); Daniel Bartozzi, Guelph (CA); Fredrick William Bent, Guelph (CA); Istvan Rado, Waterloo (CA)

Correspondence Address: DARYL W SCHNURR, BARRISTER & SOLICITOR, PO BOX 2607, 18 WEBER STREEST WEST, KITCHENER, ONTARIO, N2H 6N2, CA

(21) Appl. No.: 10/259,626

(22) Filed: Sep. 30, 2002

(51) Int. Cl. H04B 1/38

(52) U.S. Cl. 455/559; 713/300; 455/557

(57) ABSTRACT

An interface cable is used between a mobile device and a computer having a USB port. The cable has a detection device to determine whether the USB port is a host port. The cable operates within the USB 2.0 specification if the USB port is a host port and provides power from the computer to the mobile device. The cable has a micro-controller that is connected to communicate with the host system driver in the computer to enable and disable the power being provided from the computer to the mobile device. The cable provides a high speed digital data interface.

### FIELD OF INVENTION

This invention relates to an interface cable for use between a mobile device and a computer having a USB port and, more particularly, to a cable having a detection device to determine whether the USB port is a host port.

### DESCRIPTION OF THE PRIOR ART

Mobile devices, for example, Personal Digital Assistance (PDA's) and mobile phones provide users with ability to perform many tasks while mobile. These mobile devices are powerful micro-controller based devices that have local storage and processing capabilities to provide users with a rich set of features. One feature that is inherent in these mobile devices is the ability to communicate serially between the mobile device and a host computer to exchange data. The data exchanged can be for the purposes of synchronizing information, uploading and/or downloading captured data or using features provided on the attached device such as a wireless modem.

To allow communications to occur, the mobile device and the host computer must have specific software running and use a means of physically connecting the communication devices. The physical connection is typically a communications cable and is referred to as a tethered connection since it physically joins the mobile device and the host computer for the duration of the communications. The communication cables currently are typically serial cables that make use of the standard communications (COM) port of a PC host computer. These communication cables have a mobile device specific connector at one end and a DB9 or DB25 pin connector at the other end needed to mate with a standard COM port found on all PC host computers. Communication data speeds are usually 115200 kbps as this is the limit imposed by the traditional PC COM ports even though some recent PC host computers are capable at operating at higher speeds. The serial communication cables especially for mobile phones have some electronics that allow them to interface to the COM port of a host computer. The electronics within the serial communication cable requires a small amount of power from, either the COM port it is connected to, or, in the case of a cable used for a mobile phone, it typically draws power from the mobile phone itself.

Once the host computer and the mobile device are connected, software running on the host computer will communicate via the COM port to the mobile device in order to exchange and/or synchronize information between the two devices. In the case of a mobile phone, the host computer can also make use of the mobile phones built-in wireless modem capabilities to exchange information over a wireless connection to the internet, a remote modem or facsimile machine. With the introduction of faster wireless technologies and more powerful micro-controllers, the communication speed and the amount of data that needs to be exchanged between the host computer and the mobile device is increasing. Communications speeds of 115200 bps or even 230400 bps create communication bottlenecks, thus limiting applications between the mobile device and the host computer it is tethered to.

USB cables currently exist on the market that provide battery charging functionality. U.S. Pat. No. 6,184,652 (Yang), U.S. Pat. No. 6,211,649 (Matsuda) disclose such USB cables. Both the USB cables disclosed in Yang and Matsuda are specifically designed to charge batteries of the device connected to the USB cable, specifically a mobile phone. In particular, the Matsuda disclosure has a full battery charger circuit to monitor the charging process, prevent over charging and turn off the charger once the battery is fully charged. The Yang disclosure is suited to mobile phones that have built-in chargers and it discusses two designs, one to emulate a travel charger and the second to emulate a battery seat charger. The battery seat charger is also a complex design specifically for detecting and charging a battery that it is connected to. The travel charger is a very simple design providing a DC converter and voltage that is mobile phone specific. Neither the Matsuda or Yang disclosure have any provision to limit the charging based on the fact that the host device providing the USB power is itself being battery powered or that the USB host port cannot provide power for high powered devices. Both the Matsuda and Yang designs will automatically start charging the connected mobile phone battery and will only stop charging once charging is completed or power to the USB bus is removed by the host device. The Matsuda patent provides that the cable is capable of simultaneously exchanging serial data, but does not elaborate.

### SUMMARY OF THE INVENTION

In order to achieve much higher communication speeds, an alternate means of connecting the mobile device and host computer is needed. The Universal Serial Bus (USB) connection is available on virtually all host computers today. The USB connection is well suited to this application as it allows for much higher communication speeds, can optionally provide power to the mobile device and the user still views the solution as a familiar tethered cable solution. The solution would be a cable with in-line electronics; one end will have a USB connector and the other end a mobile device specific connector. The solution could act as a power source for the mobile device that is within the predefined limitations of USB but sufficient to complement the existing means of power or act as a replacement. In order to prevent the mobile device from depleting the power source of the host computer when operating on battery power, software and hardware will exist to monitor the host computer battery level and turn off power to the mobile device based on a user configured criteria.

An interface cable is used between a mobile device and a computer having a USB port. The cable comprises a USB connector at one end and a mobile connector at another end. The cable has a detection device to determine whether the USB port is a host port. The cable operates within the USB 2.0 specification if the USB port is a host port. The cable provides power from the computer to the mobile device.

### BRIEF DESCRIPTION OF THE DRAWINGS

FIG. 1 is a view showing an embodiment of the USB to mobile phone cable according to the present invention;

FIG. 2 is a view showing an embodiment of the USB to PDA cable according to the present invention;

FIG. 3 is a block diagram representation of the present invention; and

FIG. 4 is a schematic representation of the present invention.

### DESCRIPTION OF A PREFERRED EMBODIMENT

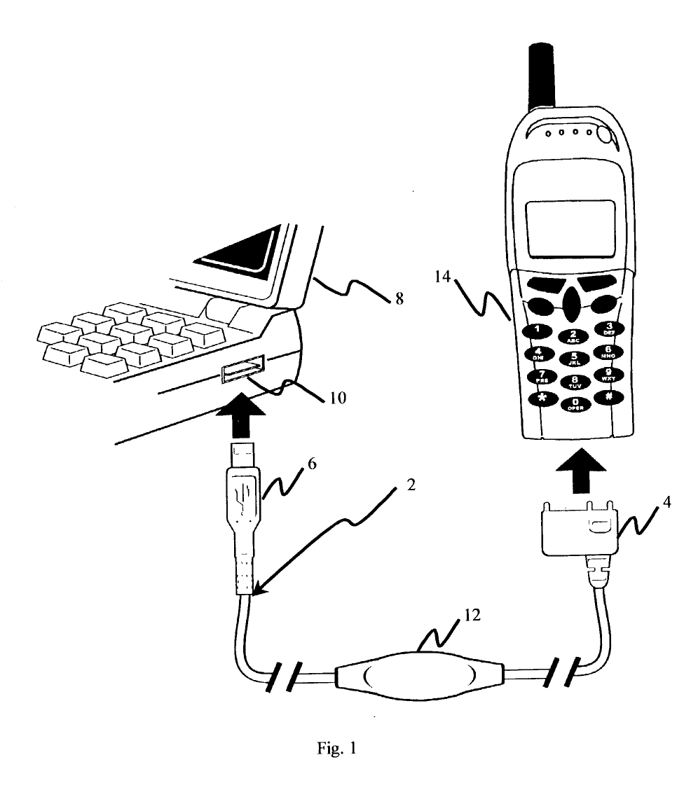

In FIG. 1, there is shown an interface cable 2 having a mobile connector 4 at one end and a USB connector 6 at another end. A computer 8 has a USB port 10. Between the ends of the cable 2, there is located in-line electronics 12. A mobile phone 14 has a connector (not shown) for connecting the mobile phone to the mobile connector 4. A PDA or other mobile device can be substituted for the mobile phone. The USB port 10 of the computer 8 can be connected to the USB connector 6.

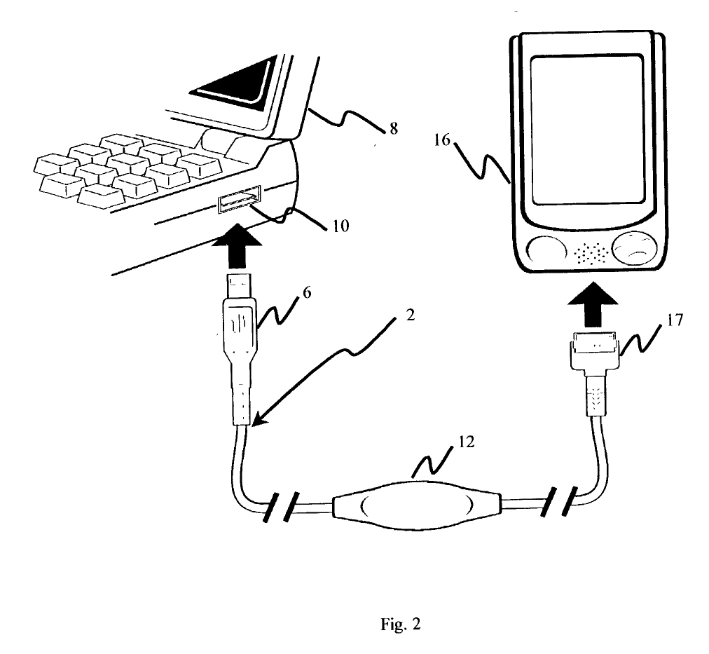

FIG. 2 is identical to FIG. 1 except that the cable 2 is connected to a PDA 16 rather than the mobile phone 14 as shown in FIG. 1. A connector 17 replaces the connector 4. The same reference numerals are used in FIG. 2 as those used in FIG. 1 to describe those components that are identical.

In both FIGS. 1 and 2, when connected, the cable electrically connects the USB port 10 of the computer with the mobile device for the purpose of exchanging serial data and supplying power from the computer via the in-line electronics 12 to the mobile device 14, 16. The present invention is not limited to the two mobile devices shown in the drawings but can be used with any mobile device that has a serial interface. The mobile device may optionally make use of the power source.

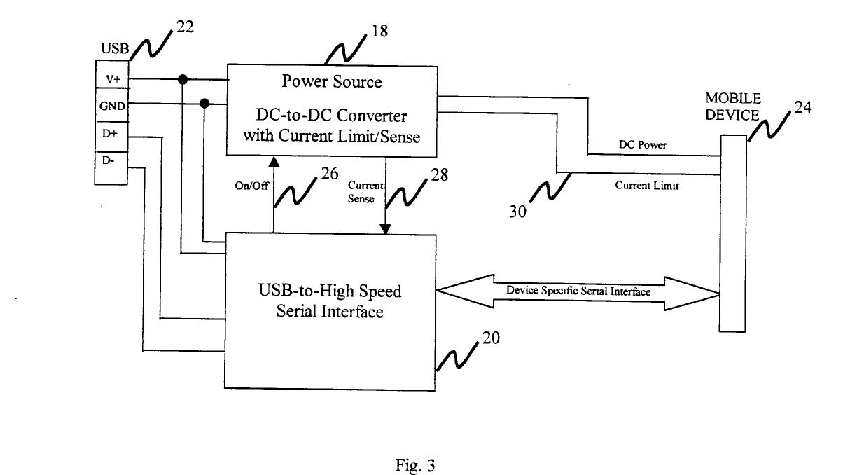

In FIG. 3, there is shown a block circuit diagram. The cable has two main functional sets of electronics, a power source 18 and a USB-to-High Speed Serial interface 20. The electrical connection to the USB port in the computer or host is via the four wire USB bus 22 that powers the power source 18 as well the USB-to High Speed Serial interface 20. The USB port 10 must support a high power USB device in order for the power source to be used. If the host USB port 10 only supports low power USB devices, the host software will automatically disable the power source 18 and the USB-to-High Speed Serial interface 20 will be functional. The electrical connection to a mobile device 24 is via a device specific connector (not shown) and the appropriate interface pins (not shown) that are specific to the mobile device. The USB-to-High Speed Serial interface 20 has control to turn the power source ON or OFF via a control pin 26. A sense line 28 extends from the power source 18 to the USB-to-High Speed Serial interface 20 to indicate if current above a pre-set value is being drawn by the attached mobile device. In addition, the attached mobile device can limit the current via a current limit control line 30 that is provided on the mobile device specific connector (not shown).

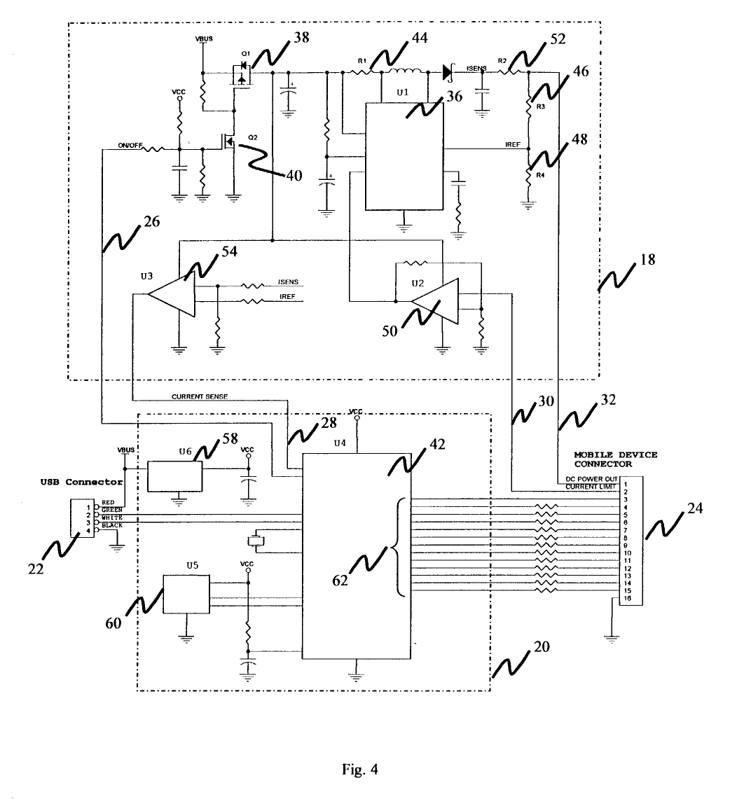

In FIG. 4, there is shown one embodiment of a circuit diagram for the present invention. The power source 18 is a DC-to-DC converter which is powered from a high power USB bus interface 22. The bus interface 22 feeds the DC-to-DC converter 18, which generates the mobile device specific voltage off a USB bus voltage of +5V DC @ 500 mA maximum (USB 2.0), and limits the maximum load current of the DC-to-DC converter to meet the USB specification, but is not limited to meet higher limits. A power output 32 of the DC-to-DC converter 18 is connected to the mobile device through a device specific connector 24. The DC-to-DC converter consists of an IC U1 36 that is connected through an electronic MOSFET switch built with Q1 38 and Q2 40 and controlled via the micro-controller 42 (ON/OFF) pin 26. This allows a micro-controller 42 to control the DC-to-DC converter 18. Sense resistor R1 44 and the DC-to-DC converter's IC's U1 36 internal current limit circuit ensures that the maximum load current to the USB port 10 does not exceed the 500 mA limit specified in the current USB 2.0 specification but is not limited to meet higher limits. The output voltage of the DC-to-DC converter 18 is set with resistors R3 46 and R4 48 according to the voltage requirement of the desired mobile device. The circuit built with IC U2 50 makes it possible for the attached mobile device to control the current limit of the DC-to-DC converter 18 via the current limit control line 30 to ensure proper operation of an internal charging circuit of the mobile device if so supported. The circuit built with resistor R2 52 and IC U3 54 form a “low current detector” whose output signal 28 is connected to the micro-controller 42 for further processing. The micro-controller 42 is the heart of the USB-to-High Speed Serial interface 20 and it derives power from the U6 58 that is a +5V to +3.3V converter needed to power the micro-controller 42. The micro-controller 42 also has local non-volatile memory in the form of an EEPROM U5 60 used to load in the configuration information. The micro-controller 42 firmware is downloaded from the host system over the USB bus and this firmware runs on internal memory within the micro-controller 42. This firmware configures the High-Speed Serial interface pins 62 specific to the desired mobile device. The High-Speed Serial interface pins 62 consists of a dedicated transmit and receive pin with all of the remaining pins being general purpose input or output pins to be used as desired. This flexibility in design allows the micro-controller 42, the running firmware and the high-speed serial interface pins 62 to confirm to virtually any mobile device serial interface.

It is an object invention to provide a cable that has a USB connector at one end, in-line electronics and a mobile device specific connector at the other end. This cable is intended to interconnect a host device that has a powered USB port with a mobile device such as a mobile phone, a PDA or another mobile device.

It is an object of the present invention to provide hardware, firmware and host software sufficient to allow High-Speed Serial communications between the host device and the mobile device. It is also an object of the present invention to provide hardware, firmware and host software sufficient to allow the provision of a power source to the mobile device so that it does not violate the USB specification and that can be automatically or manually controlled. The current USB 2.0 specification sets a maximum current draw of 500 mA for high power devices with an initial current draw not greater than 100 mA, but the present invention is not limited by the current USB 2.0 specification. Detection circuitry is also provided that determines if the USB port that the cable is plugged into is in fact a host USB port. A host USB port will exchange pre-defined information over the D+and D− signals as defined by the USB 2.0 specification. If the host USB port is detected, the present invention will operate within the USB 2.0 specification. If not detected, the present invention will automatically provide power to an attached mobile device and the serial communications functionality will not be operational. The host software will also monitor the power source of the host device and control the power source to the mobile device based on established criteria selectable by the user. In doing so, the present invention differs greatly from the prior art in that the user can control the conditions under which power can be drawn from a host device. This is especially important in cases where the host device is also battery powered and the user does not want to sacrifice the host devices battery level in favor of the attached mobile device.

It is a further object of the present invention to provide software that, when installed on the host device, will allow applications designed to communicate with the mobile device via a serial COM port to operate and provide all of the features and functions normally available. To this end, the host software will present to the application all the supported baud rates, data lengths, stop bits and parity options supported by the present invention including, but not limited to 921,600 bits per second, 8 data bits, no parity and 1 stop bit.

It is also an object of the present invention to provide software that when installed on the host device will indicate to the host operating system that it would like to keep power being applied to the present invention even though the host device may enter a lower power state. This feature of the present invention would be dependant on the operating system, host device capabilities and user selectable option to select this mode of operation. The present invention automatically emulates differing serial data cables provided by Nokia (DLR-3P and DAU-9P), one cable type being used for synchronization and the other for data and/or facsimile operation for handsets with built-in modems. The present invention, by monitoring how an application stimulates the serial port, can automatically determine which of the two cables the application requires and the present invention automatically starts to emulate the desired cable. This automatic detection and emulation is not limited to Nokia products as it is accomplished via software and can be easily applied to other manufacturers.

The present invention provides a High-Speed Serial interface including signal lines that would be typically found on a standard host PC COM port. These signal lines, including the data transfer lines are summarized in the following table but are not limited only to these signals.

TXD - Transmit Data
RXD - Receive Data
RTS - Request to Send
CTS - Clear to Send
DTR - Data Terminal Ready
DSR - Data Set Ready
CD - Carrier Detect
RI - Ring Indicator

The present invention host software will emulate the standard COM found on a PC host using the present inventions hardware and firmware to allow existing applications to operate without modification. The present invention's additional support of the higher serial data speeds will also expand the host device functionality allowing enhanced functionality between the host device and the mobile device. A user selectable configuration will also be provided as part of the present invention host software to allow a user to select the mode of power management desired by the user. The user would be able to configure if the present invention should provide power to the mobile device while operating the host device from battery power. The configuration would also have the added option of setting a battery level threshold so as not to drain the host battery level below a configured percentage.

In addition to the power management features provided by the host software, the present invention differs from prior art in that it limits current draw to under 100 mA until the host system determines if it can support a high powered USB device. After the host system has determined that it can support a high powered USB device, the present invention will further current limit the power source to ensure that it does not exceed the high powered USB device limit, which is not the case with the prior art. One other difference between the present invention and prior art is that the present invention has a control pin for the power source that will allow the attached mobile device to limit the current provided by the present invention.

Host software drivers, firmware and hardware are provided to virtualize a communications port and control activation and deactivation of the power source depending on a variety of conditions on the host computer. A micro-controller within the interface cable assembly allows dynamic adjustment of the interface signals to suit a variety of mobile device interfaces and to emulate any mobile device specific signalling.

I claim:

1. An interface cable for use between a mobile device and a computer having a USB port, said cable comprising a USB connector at one end and a mobile connector at another end, said cable having a detection device to determine whether the USB port is a host port, said cable operating within the USB 2.0 specification if said USB port is a host port, said cable providing power from said computer to said mobile device.

2. An interface cable as claimed in claim 1 wherein said interface comprises DC-2-DC converter electronics to provide power from said computer to said mobile device.

3. An interface cable as claimed in claim 1 wherein said cable comprises electronic circuitry to emulate serial data cables from a plurality of manufacturers to allow for data and/or facsimile transmission to said mobile device.

4. An interface cable as claimed in claim 2 wherein said cable has a current limit control interface to limit and control the current being provided to the mobile device.

5. An interface cable as claimed in claim 4 wherein the current limit control interface is set to ensure that the total current consumption of the cable does not exceed 500 mA, being the current USB 2.0 specification requirements.

6. An interface cable as claimed in claim 1 wherein said cable has a micro-controller that is connected to communicate with a host system driver in the computer to provide power management functionality.

7. An interface cable as claimed in claim 6 wherein the micro-controller is connected to enable and disable the power being provided from said computer to said mobile device.

8. An interface cable as claimed in claim 7 wherein the micro-controller has a sensor to determine if there is any current draw from the power source to the mobile device, said sensor being connected to communicate with the host system driver.

9. An interface cable as claimed in claim 8 wherein the cable provides a high speed digital data interface.

10. An interface cable as claimed in claim 9 wherein the high speed interface includes but is not limited to a baud rate of 921,600 bits per second, eight data bits, no parity and one stop bit.

11. An interface cable as claimed in claim 10 wherein said cable has serial control pins similar in functionality as defined by ITU-T V.24 standard, said serial control pins comprising TXD, RXD, RTS, CTS, and CD.

12. An interface cable as claimed in claim 9 wherein the serial control pins have at least one of DTR, DSR and RI.

13. An interface cable as claimed in claim 11 where said computer has host software that allows existing software applications on the computer to operate without alteration or reduction of functionality.
